(19) United States
(12) Patent Application Publication
(10) Pub. No.: US 2023/0365386 A1
(43) Pub. Date: Nov. 16, 2023

(54) INTERFACE UNIT FOR RECEPTACLE OF A PALLET ON AN UNDERRIDE SHUTTLE

(71) Applicant: Jungheinrich Aktiengesellschaft, Hamburg (DE)

(72) Inventors: Tobias RIPHAUS, München (DE); Marius LEFFLER, Aichach (DE); Romano WOLF, München (DE); Hauke GATHMANN, München (DE)

(21) Appl. No.: 18/197,449

(22) Filed: May 15, 2023

(30) Foreign Application Priority Data
May 13, 2022 (DE) 10 2022 112 079.1

(51) Int. Cl. B66F 9/18; B66F 9/06; B66F 9/24

(52) U.S. Cl. CPC B66F 9/18; B66F 9/063; B66F 9/24

(57) ABSTRACT

The present invention relates to an interface unit (10) for receiving a pallet on an underride shuttle (100), comprising an attachment unit (12) for attaching the interface unit (10) to an upper side (100a) of the underride shuttle (100) and two support portions (14, 16) which extend upwardly in parallel in accordance with a longitudinal direction (L) relative to one another and which, by means of their respective upper sides, form an exclusive support area for a pallet (200) to be supported; wherein, with respect to a width direction (B), a central recess (18) is provided between the support portions (14, 16), likewise extending in the length direction (L). Further, the invention relates to a system formed by such an interface unit (10) and a pallet, and to an underride shuttle (100) having such an interface unit (10) mounted on its upper side

The present invention relates to an interface unit for receptacle of a pallet on an underride shuttle, a system formed by such an interface unit and a pallet, and an underride shuttle comprising such an interface unit mounted on its upper side.

As part of the increasing automation of logistics devices, so-called underride shuttles have recently gained importance, which can transport loads autonomously or semi-autonomously on their upper side, such as different types of pallets with goods carried thereon. For the receptacle of such loads, they are driven under by an underride shuttle in a handover station and the corresponding loading surface on the upper side of the underride shuttle is lifted until the load is lifted from the handover station and carried thereon and can then be transported to a designated location and handed over again. For this purpose, such underride shuttles are usually configured for omnidirectional locomotion and are coordinated and controlled via a control system with regard to their operation. Since the loads to be carried by such underride shuttles can be substantial, sometimes exceeding one ton in weight, it is essential to ensure that they are reliably supported on the upper side of the underride shuttle and secured against slipping and/or tipping, since the risk of accidents due to slipping loads is considerable and recovery of such a slipped load is exceedingly costly.

For this purpose, it is known from the prior art to provide or attach more or less flat adapter plates to the upper sides of underride shuttles, on which a pallet can stand up over a large surface, as is known, for example, from EP 3 656 702. Further, the use of mandrels for coupling an underride shuttle to racks is known, for example, from WO 2006/044108 A2.

However, the solutions known from prior art for the receptacle of pallets on underride shuttles are disadvantageous in that, for example, in the event of a defect, it is difficult to take over the corresponding pallets from the underride shuttles and, furthermore, it is difficult to check the correct positioning of the corresponding pallets on the underride shuttles during their operation.

It is thus the object of the present invention to provide an improved interface unit for the receptacle of a pallet on an underride shuttle, which on the one hand can remedy the above-mentioned disadvantages from the prior art and on the other hand forms a secure support for a corresponding pallet, protected against slipping or tilting.

For this purpose, the interface unit according to the invention comprises an attachment unit for attaching the interface unit to an upper side of the underride shuttle and two support portions which extend upwardly in parallel in accordance with a length direction relative to one another and which, by means of their respective upper sides, form a sole support area for a pallet to be supported, wherein, relative to a width direction, a central depression which likewise extends in the length direction is provided between the support portions. In this manner, by means of the interface unit according to the invention, particularly when interacting with Euro pallets or similarly constructed types of pallets, the pallet can lie in the area of its central blocks in the central recess and large-area contact can only be produced via the upper boards lying on in the width direction, whereby in this manner slippage in the width direction is excluded. It is understood here that, depending on the embodiment, the interface unit according to the invention can be placed on a ceiling panel provided on the upper side of the underride shuttle, which delimits the interior space thereof upwardly, or that the interface unit itself can fulfill the function of such a ceiling panel.

Alternatively, for solving the same object, an interface unit for receptacle of a pallet on an underride shuttle can be provided, which comprises two support portions extending parallel in accordance with a length direction with respect to one another, which are displaceable in a height direction between a retracted position and an extended position, wherein, in the extended position, they form by their respective upper sides a sole support area for a pallet to be carried and comprises a displacement unit configured to cause displacement of said support portions between said retracted and extended positions, wherein in said extended position a central recess is provided between said support portions, also extending in said length direction, with respect to a width direction. Accordingly, in this alternative solution, the interface unit is integrated into the vehicle in such a manner that the other components, i.e. particularly the support portions, can be moved out of the top of the vehicle. Accordingly, the following description of exemplary embodiments of the support portions in this embodiment refers in each case to the extended position thereof.

In particular, in the interface unit according to the invention, the support portions along the length direction can each have at least one, preferably at least two, perforations, such that the corresponding support areas are each formed by at least two, preferably at least three, cusps. These perforations in the support portions provide access to the pallet in the width direction and, for example, in the event of a defect in the underride shuttle, an external forklift can take over the pallet picked up thereon from the lateral direction by driving the external forklift with its forks into the perforations and thus into the pockets provided for this purpose on the pallet, lifting the pallet and subsequently transporting it away. Here, in embodiments with at least three cusps, at least one additional support point is created between each end of the pallet in the length direction, while in embodiments with only two cusps per support portion, the pallet may deflect to a somewhat greater extent. Accordingly, the design with at least three cusps per support portion is preferred, wherein the cusps are placed in such a manner that when forks enter from the side, the free space between two cusps overlaps with the corresponding recess of the pallet in each case, so that the forks can be inserted into the pallet.

In this case, the support portions or the cusps can be designed to taper at least partially upwards in the direction of their upper sides, in particular at least from the central recess, whereby during a pallet takeover operation their correct positioning can be ensured by a corresponding centering effect, such that their support is always in the correct position. Further, the central recess, which is tapered in its lower area, means that this area is narrowly limited by the support portions or cusps in the width direction and the pallet is thus additionally protected against slipping in the width direction in the area of central pallet blocks, which would strike the support portions or cusps during such a movement.

In any case, an anti-slip layer may be provided on the upper side of the support portions and/or an upwardly extending stop may be provided on at least one end of the support portions, preferably on both ends of the support portions, in the length direction, which stop is itself no longer to be considered part of the corresponding support portion. In this manner, slippage of pallets picked up is also prevented even more reliably in the length direction of the interface unit.

Furthermore, the interface unit according to the invention may further comprise a position determining unit configured to determine a relative position of a pallet carried on the interface unit. In this manner, it can be ensured, both when a pallet is picked up and during operation of the underride shuttle equipped with the interface unit, that a picked-up pallet is in a correct relative position with respect to the interface unit, and in the event that this is not the case, the underride shuttle can be temporarily shut down, for example, or other measures can be instructed to remedy the problem.

It is conceivable, for example, that the position determining unit is formed by one or more force or voltage sensors, which can map the magnitude and distribution of the force or voltage applied by the load. However, for the same purpose, the position determining unit may also comprise at least one detection unit configured to detect a presence of an object in the width direction between the support portions at a predetermined detection position, or configured to detect a presence of an object above at least one of the support portions. In this case, for example, a portion of a pallet, and in the special case of a Euro pallet, can be detected, in particular one of the blocks in the middle in the width direction or the lower board connecting them. Alternatively, however, the position determining unit could also be arranged in such a manner that an outer block or an outer board can be detected.

In one embodiment, at least three detection units can be integrated in the interface unit, one of which is provided at each end of the support portions in the longitudinal direction, particularly outside the support portions, and one of which is provided in a central area in the longitudinal direction of the support portions.

In the embodiment of the interface unit according to the invention with perforations provided in the support portions, which has already been mentioned above, each of these support portions may comprise in particular three cusps, and each of the pairs of cusps may be associated with one of the detection units, or only the two outer pairs of cusps may each be associated with one of the detection units. In the former variant, the presence of the pallet on the interface unit can be detected in the central area, while the provision of the two detection units provided at the respective ends in the length direction can ensure that the pallet does not extend into the corresponding area and is thus present in a correct positioning with respect to the length direction. Correct positioning of the pallet in this embodiment therefore corresponds to a case in which the central detection unit reports the presence of an object, while the two outer detection units do not. Here, the respective data supplied by the detection units can be evaluated by an evaluation unit of whatever kind with regard to this condition. In the second variant mentioned, on the other hand, if the central detection unit is dispensed with, correct reception of a pallet can be determined in such a manner that the two remaining outer detection units each detect the presence of an object.

Although different embodiments of detection units may be suitable for use in an interface unit according to the invention, for example also mechanical switches which are triggered by a physical contact with a pallet, in a particularly preferred embodiment at least one of the detection units may be designed by a light barrier unit or a distance sensor, which simplifies the processing of the data supplied and at the same time enables a cost-effective and reliably operating design of the detection units. Such distance sensors can particularly be so-called reflex light barriers or distance-measuring light barriers.

Here, at least one of the light barrier units may be arranged in such a manner that the corresponding light barrier extends between two ends of one of the support portions in the longitudinal direction or between two outermost ones of the cusps in the longitudinal direction, and may be associated in particular with a pair of the upwardly extending stops, or alternatively, at least one of the distance sensors may be arranged in such a manner that a corresponding sensing area extends substantially parallel to an upper side of one of the support portions, wherein the corresponding distance sensor may be associated in particular with one of the upwardly extending stops. The presence of a pallet on the interface unit can be determined in an advantageous manner by means of a light barrier or distance sensor arranged in this manner.

Alternatively or additionally, at least one of the light barrier units or at least one of the distance sensors, in particular the two light barrier units or distance sensors provided at a respective end of the support portions in the longitudinal direction, can be arranged in such a manner that their sensing area extends obliquely in a height direction. This arrangement can ensure that reliable detection of a portion of a pallet present in this area takes place, in particular by having the path of the light barrier lie in an area in which a lower board of such a pallet, for example a Euro pallet, could lie, even if a corresponding block of the pallet were already further out in the length direction, since an exclusively horizontal detection of the board would be subject to greater uncertainty due to the dimensions of the board, which extends primarily in the horizontal direction.

A preferred embodiment of an interface unit according to the invention may be characterized in that the light barrier or a corresponding distance sensor extending longitudinally between two outermost of the cusps is combined with respective light barriers or distance sensors associated with the outermost cusps and extending obliquely upward in the width direction, wherein in such an embodiment it may be possible to dispense with the provision of a further detection unit in the area of central cusps. In this specific embodiment, the longitudinally extending light barrier can detect the presence of a pallet or a grid box, while the two oblique light barriers can detect whether the corresponding pallet or grid box is resting correctly on the interface unit.

While the data supplied by the at least one detection unit could be processed directly in the interface unit itself and, for example, a corresponding warning could be issued directly by an output unit likewise integrated there, the attachment unit can further comprise a coupling unit for an electronic connection of components of the interface unit and of the underride shuttle, such that, when a warning is issued by the at least one detection unit or by the the above-mentioned evaluation unit, an intervention could be undertaken directly by the control unit of the underride shuttle on the basis of the data supplied in this manner, for example a setting of the underride shuttle to a safe state, an immediate shutdown thereof and/or an output of a corresponding message to a control system by means of a communication unit provided for this purpose. It is understood here that in such embodiments the evaluation unit could be arranged both in the interface unit and the underride shuttle itself, and consequently either raw sensor data or data already processed by the evaluation unit could be supplied via the coupling unit.

On the other hand, the interface unit itself can also comprise an operating unit, in particular an emergency stop switch, by means of which at least one function of the underride shuttle can be operated. The transmission of corresponding control commands entered via the operating unit can also take place by means of the coupling unit of the attachment unit, but in alternative embodiments wireless communication means could also be provided on the two components and communicatively coupled for the two communication channels provided, i.e. from the at least one detection unit or evaluation unit or the operating unit of the interface unit to the control unit of the underride shuttle.

Furthermore, the present invention relates to a system formed by an interface unit of the type just described and a pallet, wherein the vertical extension of the support portions of the interface unit and the overall height of the pallet are coordinated in such a manner that the pallet, in a state resting on the interface unit, is supported only by the support portions.

Further, of course, the respective positioning of the at least one detection unit and also the geometric dimensions of the support areas with regard to their upper side can be adapted to the specific type of a pallet to be supported. Accordingly, in the case of an intended transport of clearly differing types of pallets on a single underride shuttle in a logistics facility, it may be necessary to provide several types of interface units at different times, which can be mounted on the underride shuttle or exchanged again as required.

Further, the present invention relates to an underride shuttle comprising, mounted on its upper side, an interface unit of the type described above, wherein the underride shuttle can have a substantially square outline in a plan view, and wherein the interface unit can project in the length direction through the support portions on both sides beyond the outline of the underride shuttle. In this manner, the corresponding underride shuttle can be provided with compact dimensions and thus optimized in terms of its flexibility in such a manner that even relatively narrow areas and aisles in logistics facilities become accessible for it.

As already indicated above, a control unit of the underride shuttle can be configured to receive and process data from at least one electronic component of the interface unit, for example the detection units mentioned above, the evaluation unit or the operating unit.

Further features and advantages of the present invention will become even clearer from the following description of an embodiment, when said embodiment is considered together with the accompanying drawings. In detail, the drawings show:

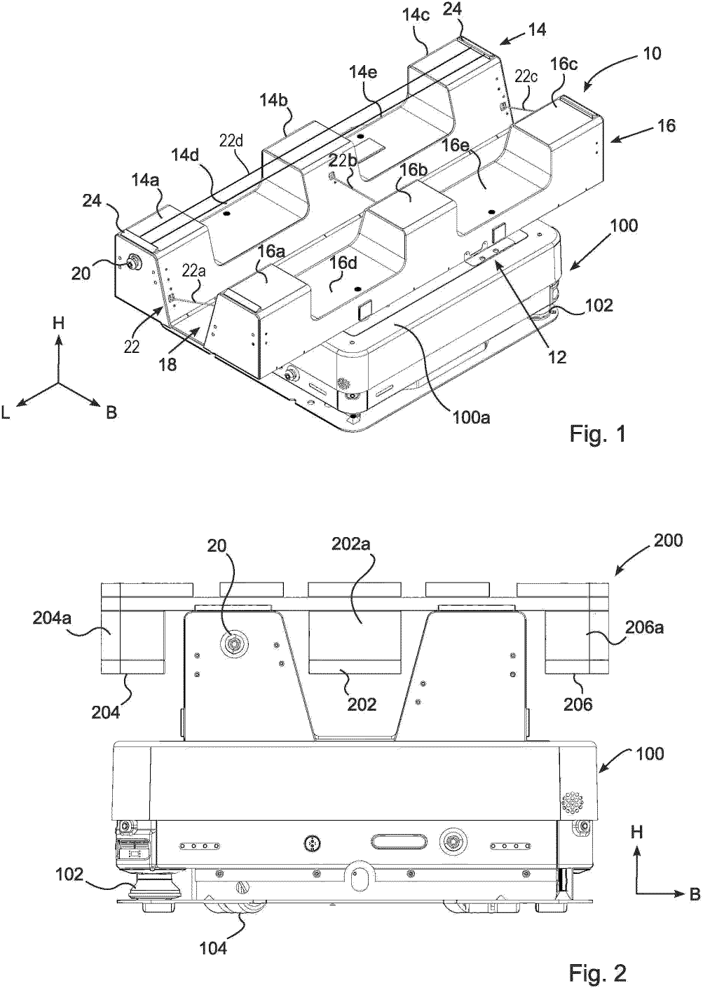

FIG. 1 shows an underride shuttle with an interface unit mounted on its upper side in accordance with the present invention in isometric view;

FIG. 2 shows the underride shuttle of FIG. 1 with a pallet mounted on the interface unit as viewed along the length direction thereof;

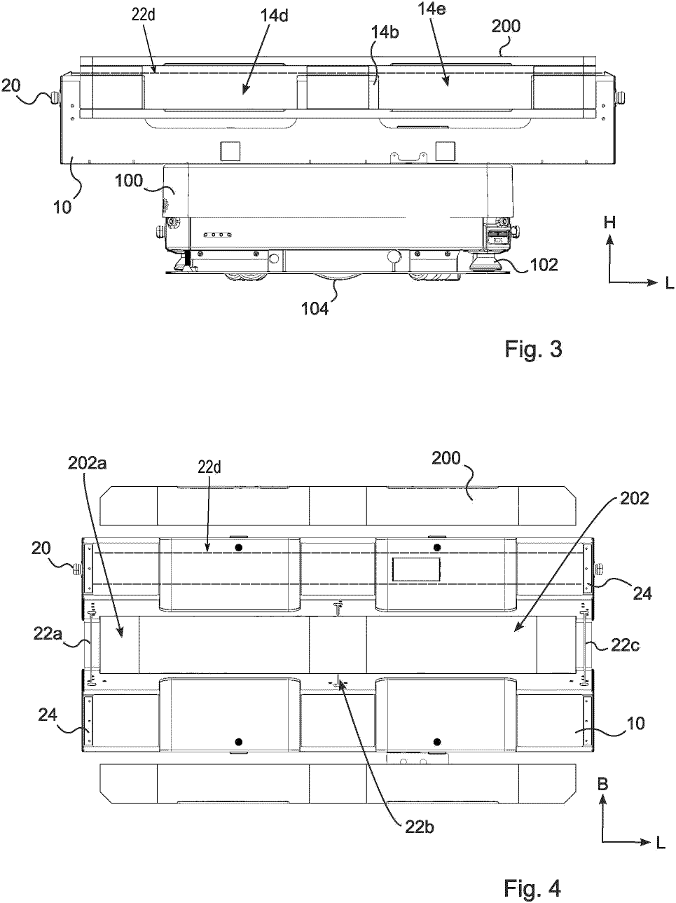

FIG. 3 shows the underride shuttle from FIG. 2 viewed along the width direction thereof;

FIG. 4 shows the underride shuttle of FIG. 2 in a plan view, wherein the top boards of the pallet are removed for visibility; and

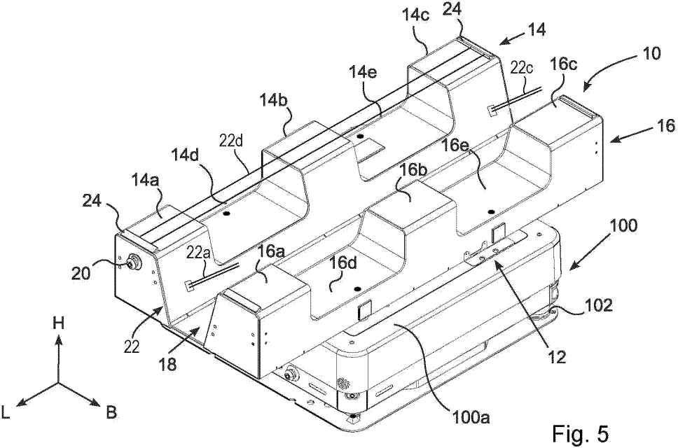

FIG. 5 shows an alternative variant of the underride shuttle from FIG. 1 in a similar view.

FIG. 1 shows an isometric view of an underride shuttle 100 with a substantially square outline in plan view, which comprises an interface unit 10 according to the invention mounted on its upper side. This interface unit 10 is mounted on an upper side 100a of the underride shuttle 100 by means of an attachment unit 12 shown only schematically, wherein a coupling unit not shown in the figures is also comprised in the attachment unit 12, which enables electrical connection of components of the interface unit 10 and the underride shuttle 100.

The basic design of the underride shuttle is known from prior art and it comprises components such as a control unit for autonomous or semi-autonomous operation, a communication unit for a data connection with an external control system, an omnidirectional locomotion system operated by the addressed control unit, as well as sensor units 102 to be recognized in the figures and provided in the corners of the underride shuttle 100, such as laser scanners for detecting its surroundings. In addition, the underride shuttle is equipped with a lifting apparatus in a manner known per se for lifting the upper side 100a and thus the interface unit 10 with respect to a ground in order to lift pallets from handover stations, for example, and place them thereon. Further, FIGS. 2 and 3 each show wheels 104 with which the underride shuttle 100 stands on the ground and which form components of the omnidirectional locomotion system referred to, by means of which locomotion of the underride shuttle 100 is made possible in a logistics environment.

Whereas the underride shuttle 100 has a substantially square ground plan, the interface unit 10 defines a length direction L as well as a width direction B, wherein in accordance with the length direction two parallel support portions 14 and 16 extend upwardly, which by their respective upper sides form a sole support area for a pallet 200 to be supported, which is shown in FIGS. 2 to 4 in the form of a Euro pallet in its usual design. Here, with respect to the width direction B, a central recess 18 is provided between the support portions 14 and 16, likewise extending in the length direction L, in which the central blocks 202a as well as the central lower board 202 of the pallet 200 can lie, while the lateral blocks 204a, 206a and lateral lower boards 204, 206 are each located in the width direction B laterally of the support portions 14 and 16, respectively, as can be seen particularly well in FIG. 2.

It should be noted at this point that, in addition to the embodiment of an underride shuttle shown here, it would also be conceivable in variants of the present invention to provide the support portions 14 and 16 in the body of the underride shuttle 100 in a horizontally retractable and extendable manner, such that they could be extended upwardly from a retracted position in a corresponding manner by means of a displacement unit, wherein the extended position of the support portions 14 and 16 would then correspond precisely to the configuration shown in the figures herein.

Furthermore, it can be seen in FIGS. 1 and 3 that the support portions 14 and 16 are each formed by three cusps 14a to 14c and 16a to 16c, respectively, as they have two perforations 14d and 14e and 16d and 16e along the length direction L, respectively. In the view in accordance with the width direction B of FIG. 3, it can be seen that the blocks of the pallet 200 and the cusps 14a to 14c or 16 to 16c are aligned with one another in such a manner that the perforations 14d, 14e or 16d, 16e allow a fork of another external industrial truck to enter the pockets of the pallet, by means of which the pallet 200 can be picked up from the width direction B and recovered, for example, in the event of a malfunction of the underride shuttle 100.

It can further be seen in the view along the length direction L from FIG. 2 that the interface unit 10 is provided with an operating unit 20 in the form of an emergency stop switch, which is coupled to the control unit of the underride shuttle 100 via the coupling unit mentioned above and can be operated for an emergency stop of the underride shuttle 100.

Furthermore, the interface unit 10 comprises a position determining unit 22 having four detection units 22a to 22d in the form of light barrier units, wherein each of the cusps 14a to 14c or 16a to 16c, respectively, is associated with one of the light barrier units 22a to 22c, each of which extends in the width direction B over the central recess 18 and thus defines respective sensing areas, wherein further a fourth light barrier unit 22d is provided which is arranged in such a manner that the corresponding light barrier extends between the two outermost cusps 14a and 14c of the first support portion 14 in the longitudinal direction L above the corresponding support surface, wherein the light barrier unit 22d is associated in particular with the pair of upwardly extending stops 24 described below.

It should be noted at this point that not all of the light barrier units 22a to 22d need to be present in interface units according to the invention, but only a subset thereof can also be provided. In particular, it would be conceivable to combine the outer light barrier units 22a and 22c in the longitudinal direction L with the fourth light barrier unit 22d extending in the longitudinal direction L, omitting the middle light barrier unit 22b. Alternatively, however, it would be conceivable to provide only the three light barrier units 22a to 22c arranged between respective pairs of cusps 14a - 14c and 16a - 16c, wherein the operation of such an arrangement shall be described below. Further, it should also be noted that one or more of the light barrier units 22a to 22d could also be replaced in an analogous manner by a distance sensor capable of detecting the presence of an object in its vicinity.

Here it can be seen in particular in FIG. 1 that the light barrier units 22a and 22c are provided at a respective end of the support portions 14 and 16 in the length direction L and are arranged outside thereof in such a manner that they are already located in the area of the upwardly extending stops 24 for limiting the support areas in the length direction, i.e. in an area in which a correctly supported pallet is already no longer located, as can be seen from the view in FIG. 4.

Furthermore, the two outer light barrier units 22a and 22c are arranged in such a manner that the respective sensing area, i.e. the extension of the light barrier extends obliquely in a height direction H in order to lie in the area of the central lower board 202 thereof and to be able to detect this in any case in the event of incorrect positioning of a pallet 200.

On the other hand, the correct positioning of the pallet 200 on the interface unit 10, as shown in FIG. 4, is characterized by the fact that the central middle block of the pallet 200 interrupts the central light barrier unit 22b, while the two outer light barrier units 22a and 22c are not interrupted, in such a manner that, on the one hand, the presence of the pallet 200 is detected, but, on the other hand, it is ensured that it is located within the report delimited by the two outer light barrier units 22a and 22c.

For evaluation of the data supplied by the light barrier units 22a to 22c, an evaluation unit not shown here can be provided either in the interface unit 10 itself or in the underride shuttle 100, which unit can, for example, be operatively coupled to the control unit of the underride shuttle 100 or integrated therein in order to be able to trigger a corresponding reaction of the underride shuttle 100 to the evaluation results thus supplied.

In this context, the evaluation of the light barrier units can either show that they are interrupted or not. An error event, i.e. an incorrectly placed pallet 200, is detected here when the middle light barrier unit 22b is interrupted and also one of the other two light barrier units 22a or 22c. Similarly, if the light barrier unit 22b is not interrupted, but at least one of the other two light barrier units 22a or 22c is, an error is present.

A correctly picked-up pallet, on the other hand, is detected by means of the middle light barrier unit 22b being interrupted exclusively, as described above. An unloaded underride shuttle would be detected by three uninterrupted light barrier units 22a-c, wherein it is conceivable that another sensor, not shown here, is also evaluated to determine the mass of a load being picked up to preclude a pallet that has shifted in an extreme manner from being located on the interface unit 10 in such a manner that none of the three light barrier units 22a-c are interrupted.

Finally, reference should be made to the variant shown in FIG. 5, in which only three detection units 22a, 22c and 22d are provided in the manner already briefly mentioned above, while the middle detection unit 22b has been dispensed with compared with the variant shown in FIG. 1. It should further be noted here that the two detection units 22a and 22c associated with the outer pairs of cusps 14a, 16a and 14c, 16c, respectively, are formed by distance sensors instead of light barrier units in this variant, such that their respective detection range extends and is shown in FIG. 5 in a somewhat different manner. In this context, it should also be mentioned that in the variant shown in FIG. 5, the detection units 22a and 22c are offset further toward a central area of the interface unit with respect to their length direction L compared to the embodiment shown in FIG. 1. Accordingly, in this variant, correct receptacle of a pallet is detected when the two detection units 22a and 22c each detect the presence of an object, which is also in contrast to the above-described embodiment of FIG. 1, in which - as can be understood in particular from FIG. 4 - the absence of an object in the detection range of the light barrier units 22a and 22c is required to ensure correct positioning of the corresponding pallet 200.

1. An interface unit for a receptacle of a pallet on an underride shuttle, comprising:
an attachment unit for attaching the interface unit to an upper side of the underride shuttle
two support portions extending upwards parallel to one another in accordance with a length direction and forming by their respective upper sides a support area for a pallet to be supported; and
wherein, with respect to a width direction, a central recess likewise extending in the length direction is provided between the support portions.

2. (canceled)

3. The interface unit according to claim 1, wherein the support portions along the length direction each have at least one perforation, such that each support area is formed by cusps.

4. The interface unit of claim 1, wherein the support portions taper upward in a direction of their respective upper sides; from the central recess.

5. The interface unit of claim 1, wherein each of the respective upper sides of the support portions includes an anti-slip layer.

6. The interface unit of claim 1, further comprising a position determining unit configured to determine a relative position of a pallet carried on the interface unit.

7. The interface unit according to claim 6, wherein the position determining unit comprises at least one detection unit configured to detect a presence of an object in the width direction between the support portions at a predetermined detection position.

8. The interface unit according to claim 7, comprising at least three detection units, one of which is provided at each end of the support portions in the length direction outside the support area, and one of which is provided in a central area in the length direction of the support portions.

9. The interface unit according to claim 8, wherein each of the two support portions comprises three cusps, each of the three cusps of one support portion being paired with a corresponding cusp of the other support portion to form pairs of cusps, wherein at least the two of the pairs of cusps are associated with the detection unit.

10. The interface unit according to claim 7, wherein at least one of the detection units comprises a light barrier unit or a distance sensor.

11. The interface unit according to claim 10, wherein at least one of the light barrier units is arranged in such a manner thata corresponding light barrier extends between two ends of one of the support portions ina longitudinal direction .

12. The interface unit according to claim 10, wherein at least one of the light barrier units or at least one of the distance sensors is arrangedsuch that its sensing area extends obliquely in a height direction.

13. The interface unit according to claim 1, wherein the attachment unit further comprises a coupling unit for electronically connecting components of the interface unit (10) and the underride shuttle.

14. The interface unit according to claim 1, further comprising an operating unit configured to operate at least one function of the underride shuttle .

15. The interface unit according claim 1 and a pallet, whereina vertical extension of the support portions of the interface unit andan overall height of the pallet are substantially matched that the pallet is supported by the support portions in a state resting on the interface unit.

16. (canceled)

17. (canceled)

18. (canceled)

19. The interface unit of claim 1, wherein the interface unit is mounted on the upper side of the underride shuttle.

20. The interface unit of claim 19, wherein the underride shuttle has a substantially square outline in a plan view, and wherein the interface unit projects beyond the outline of the underride shuttle in the length direction through the support portions on both sides.

21. The interface unit of claim 19, wherein a control unit of the underride shuttle is configured to receive and process data from at least one electronic component of the interface unit.

22. The interface unit of claim 1, wherein support portions the cusps taper upward in a direction of their respective upper sides from the central recess.

23. The interface unit of claim 1, wherein at least one end of the support portions includes an upwardly extending stop in the length direction.

24. The interface unit according to claim 6, wherein the position determining unit comprises at least one detection unit configured to detect a presence of an object above at least one of the support portions.

25. The interface unit according to claim 10, wherein each of the two support portions comprises at least three cusps and wherein at least one of the light barrier units is arranged in such a manner that a corresponding light barrier extends respectively between two outermost ones of the cusps in a longitudinal direction.

26. The interface unit according to claim 25, wherein at the light barrier is associated with a pair of upwardly extending stops or wherein at least one of the distance sensors is arranged in such a manner that a corresponding sensing area extends substantially parallel to an upper side of one of the support portions in the longitudinal direction, the corresponding distance sensor being associated in particular with one of the upwardly extending stops.

27. The interface unit according to claim 26, wherein at least one of the distance sensors is arranged in such a manner that a corresponding sensing area extends substantially parallel to an upper side of one of the support portions in the longitudinal direction, the corresponding distance sensor being associated in particular with one of the upwardly extending stops.

28. The interface unit according to claim 14, wherein the operating unit comprises an emergency stop switch.

29. An interface unit for a receptacle of a pallet on an underride shuttle, comprising:
two support portions extending parallel to one another in accordance with a length direction, which are displaceable in a height direction between a retracted position and an extended position, wherein in the extended position they form by their respective upper sides a support area for a pallet to be supported;
a displacement unit configured to effect displacement of the support portions between the retracted and extended positions; and
wherein, in the extended position relative to a width direction, a central recess likewise extending in the length direction is provided between the support portions.
